(19) United States
(12) Patent Application Publication
(10) Pub. No.: US 2025/0372328 A1
(43) Pub. Date: Dec. 4, 2025

(54) DYNAMIC ADJUSTABLE MAGNETIC YOKE ASSEMBLY FOR ELECTROMECHANICAL SWITCHING DEVICES

(71) Applicant: SENSATA TECHNOLOGIES, INC., ATTLEBORO, MA (US)

(72) Inventors: CORY Z. BOUSQUET, UXBRIDGE, MA (US); SAMUEL C. NAUMOWICZ, DENVER, CO (US); KEITH R. WASHBURN, HOLLISTON, MA (US); JAMES M. MALOOF, WESTWOOD, MA (US); JUNE PARK, Rumford, RI (US); CALVIN S. REUTER, CUMBERLAND, RI (US)

(21) Appl. No.: 18/876,657

(22) PCT Filed: Sep. 1, 2022
(86) PCT No.: PCT/US2022/042364

§ 371 Date: Dec. 18, 2024

Related U.S. Application Data
(60) Provisional application No. 63/397,111, filed on Aug. 11, 2022.

(51) Int. Cl. H01H 50/36; H01H 49/00; H01H 50/54

(52) U.S. Cl. CPC H01H 50/36; H01H 49/00; H01H 50/54

(57) ABSTRACT

Electromechanical switching devices and methods of manufacturing electromechanical switching devices that include a dynamic adjustable magnetic yoke assembly are disclosed. In a particular embodiment, an electromechanical switching device includes a moveable contact, one or more magnetic upper yokes provided above the moveable contact and separate from the moveable contact, a magnetic lower yoke provided below the moveable contact, and one or more collapsible bias members supporting the upper yoke.

### FIELD OF THE TECHNOLOGY

The subject disclosure relates to a dynamic adjustable magnetic yoke assembly for electromechanical switching devices.

### BACKGROUND

As electrical power levels continue to increase across industries, it is becoming increasingly difficult to design systems that safely handle accidents and emergencies resulting in high current short-circuits. This difficulty often results from an inability to find switching devices designed to withstand such short-circuits. Switching devices that fail to withstand exposure to a short-circuit event experience a variety of failure modes ranging from a loss of switching function to fire and/or explosion. These failures commonly result from short-circuit currents generating enough force to separate the internal electrical contacts. This contact separation (or levitation) generates an electric arc that increases the series resistance of the switching device, producing extreme heat and the failure modes described above. Separation can be prevented by increasing the force between the electrical contacts conducting the short-circuit current, commonly achieved with an assembly of ferromagnetic yokes arranged around the current-carrying members. The yokes are physically separated by a functional gap where an attractive magnetic field is generated in response to electrical current in the current-carrying members. The size of this functional gap impacts the amount of increased contact force. Existing solutions have a functional gap with a static and unchanging size while the electrical contacts are mated and the switching device is on, regardless of the applied current. This results in a static relationship between electrical current and generated increase in contact force that negatively impacts other device characteristics.

### SUMMARY

In a particular embodiment, a mechanism for preventing separation of electrical contacts during short-circuit in switching devices such as high-voltage DC contactors, fuses, and pyrotechnic fuses is described that makes use of ferromagnetic yokes with a functional gap that dynamically adjusts in response to applied current while the electrical contacts are mated and the switching device is on. This creates a dynamic relationship between electrical current and increased contact force that allows short-circuit withstand performance to be maximized without the negative effects (e.g., reduced current interruption) experienced by existing solutions utilizing a static and unchanging functional gap.

An embodiment is directed to an electromechanical switching device having a dynamic adjustable magnetic yoke assembly. The switching device includes a moveable contact; a one or more magnetic upper yokes provided above the moveable contact; a magnetic lower yoke provided below the moveable contact; and one or more collapsible bias members supporting one or more of the magnetic yokes. In some examples, the one or more collapsible bias members include one or more springs. In other examples, the one or more collapsible bias members include one or more fracturing break-away structures that release and allow movement in one or more magnetic yokes. In some variations, the switching device includes a support member having one or more cavities to seat the one or more collapsible bias members, wherein one or more magnetic yokes are mounted on the one or more collapsible bias members.

Another embodiment is directed to a method of manufacturing an electromechanical switching device having a dynamic adjustable magnetic yoke assembly. The method includes mounting a one or more magnetic upper yokes on one or more collapsible bias members above a moveable contact; and mounting a magnetic lower yoke below the moveable component. In some variations, the one or more collapsible bias members include one or more springs. In other variations, the one or more collapsible bias members include one or more break-away structures.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a diagram illustrating a cross-sectional view of an example simplified switching device that includes a magnetic yoke assembly with a static functional gap.

FIG. 2 is a diagram illustrating a cross-sectional view of another example simplified switching device that includes a magnetic yoke assembly with a static functional gap.

FIG. 3 is a diagram illustrating forces on a magnetic yoke assembly.

FIG. 4 is a diagram of a simplified version of a magnetic yoke assembly.

FIG. 5 is a diagram illustrating a cross-sectional view of an example dynamic adjustable magnetic yoke assembly in accordance with at least one embodiment of the present disclosure.

FIG. 6 is a diagram illustrating a cross-sectional view of another example dynamic adjustable magnetic yoke assembly in accordance with at least one embodiment of the present disclosure

FIG. 7A is a diagram illustrating a cross-sectional view of an example simplified switching device that includes a dynamic adjustable magnetic yoke assembly in accordance with at least one embodiment of the present disclosure.

FIG. 7B is a diagram illustrating a cross-sectional view of the example switching device of FIG. 7A in a short-circuit state.

FIG. 8 is a diagram illustrating a side cross-sectional view of an example electromechanical switching device that includes a dynamic adjustable magnetic yoke assembly in accordance with at least one embodiment of the present disclosure.

FIG. 9 is a diagram illustrating another side cross-sectional view of the example electromechanical switching device of FIG. 8, where the view is rotated 90 degrees.

FIG. 10 is a diagram illustrating an exploded view of the example electromechanical switching device of FIG. 8.

FIG. 11A is a diagram illustrating a side cross-sectional view of the example electromechanical switching device of FIG. 8, where the switching device is in an open state.

FIG. 11B is a diagram illustrating another side cross-sectional view of the example electromechanical switching device of FIG. 8, where the switching device is in a closed state.

FIG. 11C is a diagram illustrating a side cross-sectional view of the example electromechanical switching device of FIG. 8, where the switching device is in a short circuit state.

FIG. 12 is a diagram illustrating an upper isometric view of an electromechanical switching device that includes a dynamic adjustable magnetic yoke assembly according to at least one embodiment of the present disclosure.

FIG. 13 is a diagram illustrating an upper isometric view of a dynamic adjustable magnetic yoke assembly according to at least one embodiment of the present disclosure.

FIG. 14 is a diagram illustrating an upper isometric view of an upper yoke of a dynamic adjustable magnetic yoke assembly according to at least one embodiment of the present disclosure.

FIG. 15 is a graph of data that indicates short-circuit and current interruption performance of an electromechanical switching device with a dynamic adjustable magnetic yoke assembly according to at least one embodiment of the present disclosure.

FIG. 16 is a graph of data that indicates yoke force vs. functional gap for an electromechanical switching device that includes a static magnetic yoke assembly and an electromechanical switching device that includes a dynamic adjustable magnetic yoke assembly according to at least one embodiment of the present disclosure.

FIG. 17 sets for a flow chart illustrating a method of manufacturing a dynamic adjustable magnetic yoke assembly for electromechanical switching devices according to at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Electromechanical switching devices, such as contactors and relays, are designed to carry a certain amount of electrical current for certain periods of time. Existing designs struggle to perform during the very high current, short duration events commonly called short-circuits, which can cause the internal electrical contacts to separate destructively (commonly called contact levitation). One solution to this problem involves the use of ferromagnetic components, known as yokes or armatures, configured around the electrical contacts such that the short-circuit current induces a magnetic field and an attractive “anti-levitation” force between the ferromagnetic components that prevent the electrical contacts from separating. For example, the yokes can be rigidly mounted onto the moving assembly and the envelope, resulting in a functional gap between the yokes that does not change once the switching device is turned on. The static functional gap and rigid mounting introduce performance trade-offs, negatively impacting important performance characteristics such as coil power consumption and current interruption. For example, the use of rigidly mounted yokes and a static functional gap means high force is generated any time current is applied to the switching device. This creates a trade-off between short circuit withstand performance, where high force is desirable, and current interruption performance, where low force is desirable.

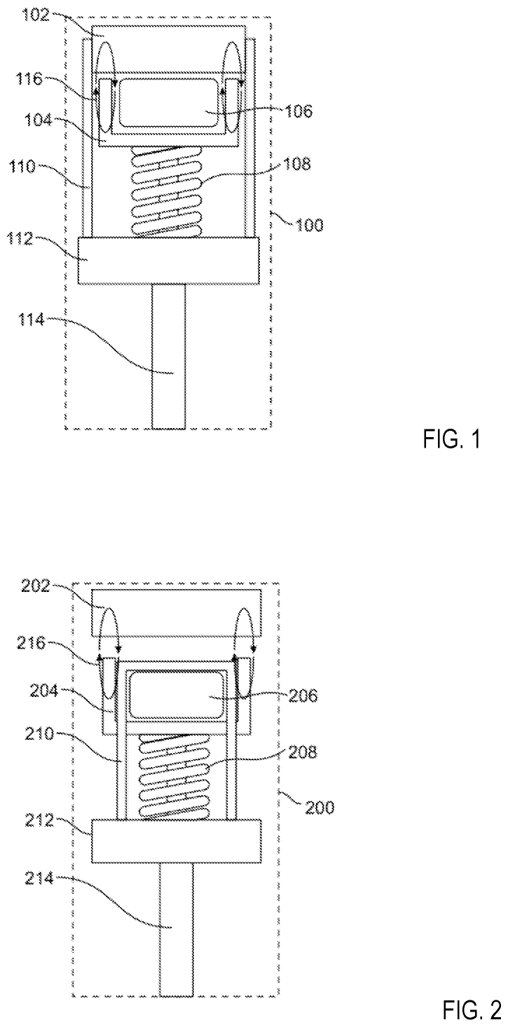

Exemplary apparatuses, systems, and methods for manufacturing a dynamic adjustable magnetic yoke assembly for electromechanical switching devices according to the present disclosure are described with reference to the accompanying drawings, beginning with FIG. 1. FIG. 1 sets forth a block diagram of an example of a floating yoke design for an electromechanical switch assembly 100. In the example of FIG. 1, the assembly 100 includes a floating ferromagnetic upper 102 yoke and a ferromagnetic lower yoke 104, and a movable contact 106 that is driven by a plunger shaft 114. In the example of FIG. 1, the upper yoke 102 is substantially planar and the lower yoke 104 is U-shaped. However, other examples may employ a reverse of this configuration, where the upper yoke 102 is U-shaped and the lower yoke 104 is planar. When the electromechanical switch is in the actuated position, the moveable contact 106 is held in contact with one or more terminals (not shown) by a contact spring 108 and an actuator 112, thus closing the switch. When the electromechanical switch is not in the actuated position, the moveable contact 106 is pulled away from the terminals by the actuator 112 and the shaft 114, thus opening the switch. During a short-circuit event, the Lorentz forces 116 created by the increased current induced in the upper yoke 102 and lower yoke 104 cause the yokes to clamp down on the moveable contact 106, thus holding the moveable contact 106 in contact with the terminals to prevent failure modes. During breaking, the Lorentz forces between the yokes 102, 104 facilitate opening the contact between the moveable contact 106 and the terminals. However, in a floating yoke arrangement, the upper yoke 102 is coupled to the actuator subassembly by a support member 110, thus the upper yoke 102 moves with the actuator subassembly (e.g., the actuator 112 and shaft 114). While this may be advantageous in that the tolerance stack of the yokes 102, 104 is constrained to single subassembly, anti-levitation effects are constrained by the solenoid actuator. Moreover, while the yokes 102, 104 supplement the spring force applied by the contact spring 108, they do not supplement the force applied by the actuator.

For further explanation, FIG. 2 sets forth a block diagram of an example of a fixed yoke design for an electromechanical switch assembly 200. In the example of FIG. 1, the assembly 200 includes a fixed ferromagnetic upper 202 yoke and a ferromagnetic lower yoke 204, and a movable contact 206 that is driven by an actuator 212 and a plunger shaft 214 within a guide member 210. In the example of FIG. 2, the upper yoke 102 is substantially planar and the lower yoke 204 is U-shaped. However, other examples may employ a reverse of this configuration, where the upper yoke 202 is U-shaped and the lower yoke 204 is flat or planar. When the electromechanical switch is in the actuated position, the moveable contact 206 is held in contact with one or more terminals (not shown) by a contact spring 208 and the actuator 212, thus closing the switch. When the electromechanical switch is not in the actuated position, the moveable contact 206 is pulled away from the terminals by the actuator 212 and the shaft 214, thus opening the switch. During breaking, Lorentz forces 216 between the yokes 202, 204 facilitate opening the contact between the moveable contact 206 and the terminals. In a fixed yoke arrangement, the upper yoke is fixed inside a chamber of the electromechanical switch. While the mass of the moving actuator subassembly is lower than that of that of the floating yoke design, the yokes 202, 204 may interfere with the actuator opening speed. Moreover, the arc breaking capability is directly coupled to the Lorentz forces, and very tight tolerances are needed to balance anti-levitation and breaking performances.

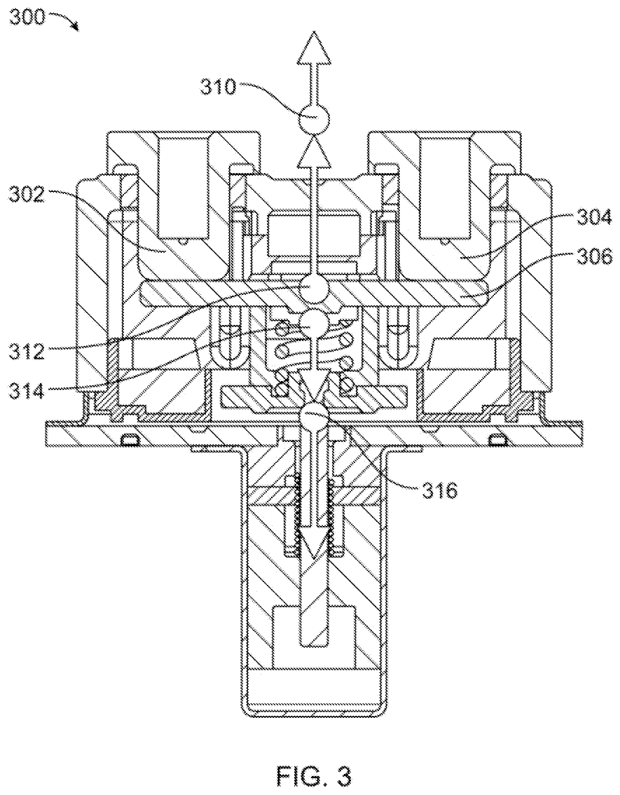

For further explanation, FIG. 3 sets forth a force diagram for an example electromechanical switch assembly 300. In the example of FIG. 3, the electromechanical switch assembly 300 includes two terminals 302, 304 and a moveable contact 306 that contacts the terminals 302, 304 when the switch is closed, as depicted. During a short-circuit event, arrow 310 notes a yoke force applied by two yokes holding the moveable contact 306 in a closed position, arrow 312 notes a spring force applied by a contact spring holding the moveable contact 306 in a closed position, arrow 314 notes a repulsion force caused by the short-circuit, and arrow 316 notes a reaction force of the actuator.

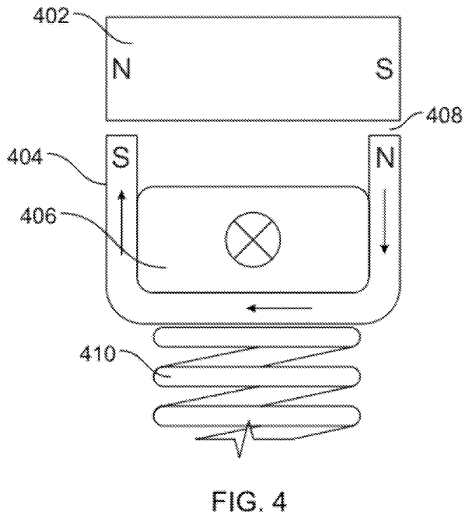

For further explanation, FIG. 4 sets forth a block diagram of an example yoke assembly 400 having a fixed upper yoke 402 and a lower yoke 404 that interfaces with a moveable contact 406. In a fixed yoke arrangement, a static functional gap 408 is maintained between the upper yoke 402 and the lower yoke 404 when the moveable contact 406 is in the closed position held by a contact spring 410. The distance selected for the static functional gap represents a tradeoff between break performance and short-circuit (anti-levitation) performance. While high short-circuit anti-levitation mechanisms use magnetic yokes to increase contact force and prevent contact separation at high currents, breaking mechanisms require a rapid opening of the contact to break current, which is slowed down by the anti-levitation mechanisms. The ideal performance of the electromechanical switch may depend on the current experienced by the switch. For example, a large functional gap leads to a low anti-levitation force but faster breaking. A small functional gap leads to high anti-levitation force but slower breaking. Moreover, the tolerance stack up between yokes and actuator parameters can further confound performance of levitation and breaking. Thus, a yoke assembly that utilizes a static or fixed functional gap while contacts are closed results in a large trade-off between short-circuit performance and break performance due to the fact that higher forces are desirable for short-circuit performance, but lower forces are desirable for break performance (in that higher forces force reduce opening speed and negatively impacting breaking).

To better reconcile these competing factors, embodiments in accordance with the present disclosure provide a dynamic adjustable magnetic yoke assembly for electromechanical switching devices. Embodiments provide a moveable upper yoke that is positioned and stabilized by one or more collapsible bias members (e.g., a spring), thus creating a Z-Axis degree of freedom for upper yoke so it is no longer fixed. As will be explained in detail below, the position of the upper yoke is made a function of the current level such that the upper yoke will “pull-in” toward the lower yoke once the electromechanical switch transitions outside of normal breaking levels into fault current levels. During breaking, the upper yoke should not slow down the opening speed of the contacts; however, at-and-above levitation currents for the contact spring, the yokes should help keep contacts closed.

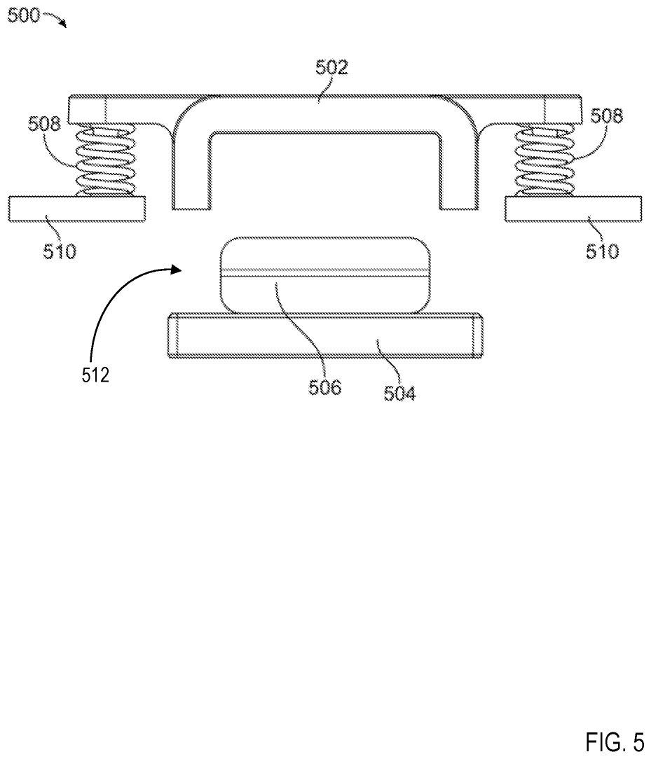

For further explanation, FIG. 5 sets forth a diagram illustrating a front view of an example dynamic adjustable magnetic yoke assembly 500 for electromechanical switching devices. The example yoke assembly 500 includes a ferromagnetic upper yoke 502, a ferromagnetic lower yoke 504, and a moveable contact 506 coupled to or otherwise interfacing with the lower yoke 504. The upper yoke 502 is supported on a platform 510 of a support structure, housing, body, or other fixed component by collapsible bias members that support a bias position of the upper yoke 502 below a trigger current (i.e., during normal operation or breaking operation) and that facilitate the upper yoke 502 to assume a different position at or above the trigger current (i.e., during short-circuit operation).

In the example of FIG. 5, the collapsible bias members are embodied by springs 508. The springs 508 support the upper yoke 502 in a first position under normal current levels, where Lorenz forces act to keep the moveable contact in a closed state. In this first position, the functional gap 512 between the upper yoke 502 and the lower yoke 504 may be relatively larger to facilitate rapid breaking. When the current exceeds a threshold, the springs 508 begin to collapse under the increased Lorentz forces, thus reducing the functional gap 512 between the upper yoke 502 and the lower yoke 504 and increasing the Lorentz forces even more. The springs 508 may be selected such that the springs 508 respond to the trigger current. Consider an example where a break is characterized by 2500 amperes or less and a short-circuit is characterized as 4000 amperes or more. In such an example, the spring force of the springs 508 should always exceed the Lorentz force when the current in the electromechanical switch is less than a trigger current (e.g., 2500 amperes) and the Lorentz force should always exceed the spring force when the current in the electromechanical switch is greater than a short-circuit current (e.g., 4000 amperes). Between these current levels, the springs 508 should collapse.

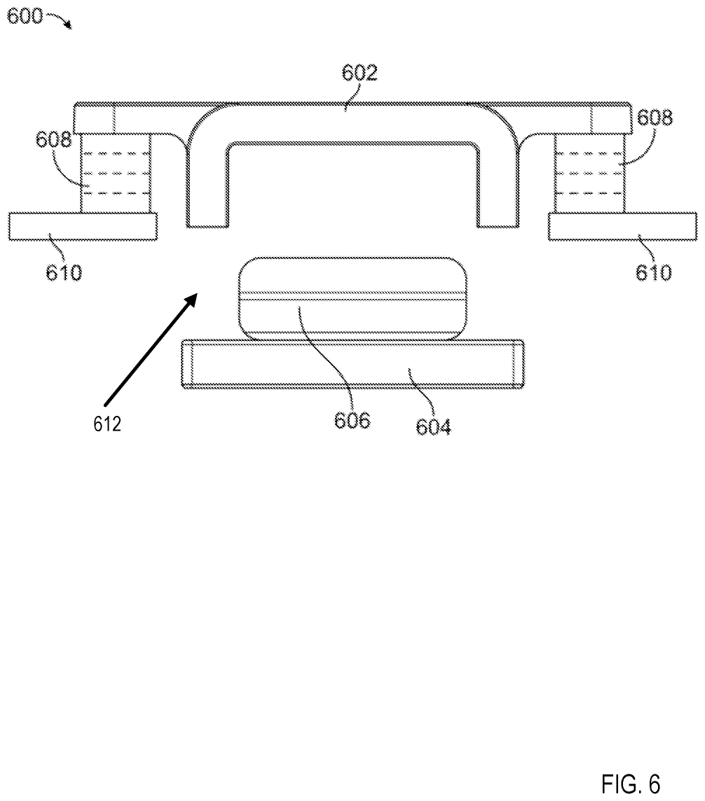

For further explanation, FIG. 6 sets forth a diagram illustrating a front view of another example dynamic adjustable magnetic yoke assembly 600 for electromechanical switching devices. The example yoke assembly 600 includes a ferromagnetic upper yoke 602, a ferromagnetic lower yoke 604, and a moveable contact 606 coupled to or otherwise interfacing with the lower yoke 604. The upper yoke 602 is supported on a platform 610 of a support structure, housing, body, or other fixed component by collapsible bias members that support a bias position of the upper yoke 602 below a trigger current (i.e., during normal operation or breaking operation) and that facilitate the upper yoke 602 to assume a different position at or above the trigger current (i.e., during short-circuit operation).

In the example of FIG. 6, the collapsible bias members are embodied as break-away structures 608. In one example, the break-away structures 608 are support structures that crumple, shatter, bend, or otherwise collapse in the presence of a force applied to the break-away structures 608, thus allowing the upper yoke 602 an additional degree of movement. In one example, during a short-circuit, a pyrotechnic fires and pushes portions of the upper yoke through the notched plastic break-away feature. The break-away structures 608 support the upper yoke 602 in a first position under normal current levels, where Lorenz forces act to keep the moveable contact in a closed state. In this first position, the functional gap 612 between the upper yoke 602 and the lower yoke 604 may be relatively larger to facilitate rapid breaking. When the current exceeds a threshold, the break-away structures 608 give under the increased Lorentz forces, thus reducing the functional gap 612 between the upper yoke 602 and the lower yoke 604 and increasing the Lorentz forces even more. The break-away structures 608 may be selected such that the break-away structures 608 respond to the trigger current. Consider an example where a break is characterized by 2500 amperes or less and a short-circuit is characterized by 4000 amperes or more. In such an example, the resistance force of the break-away structures 608 should always exceed the Lorentz forces when the current in the electromechanical switch is less than a trigger current (e.g., 2500 amperes) and the Lorentz force should always exceed the resistance force of the break-away structures 608 when the current in the electromechanical switch is greater than a short circuit current (e.g., 4000 amperes). Between these current levels, the break-away structures 608 should collapse.

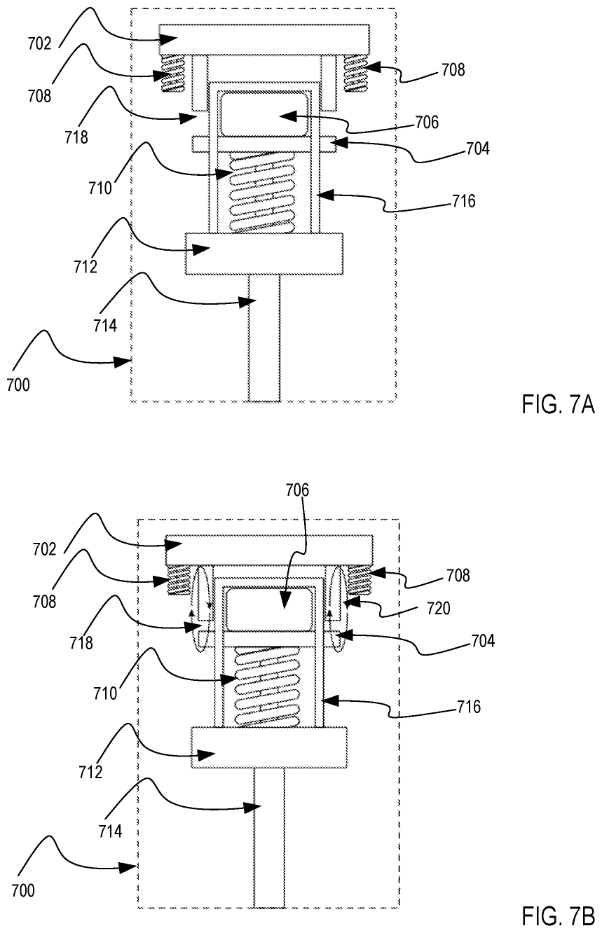

For further explanation, FIG. 7A sets forth a sectional block diagram illustrating another example dynamic adjustable magnetic yoke assembly 700 for electromechanical switching devices. The example assembly 700 includes a ferromagnetic upper yoke 702, a ferromagnetic lower yoke 704, and a moveable contact 706 that is coupled to or otherwise interfaces with the lower yoke 704. The assembly 700 further includes yoke springs 708 that support the upper yoke 702 on a platform of a support member, housing, body, or other static structure (not shown). In the actuated position, a plunger shaft 714 extending through body member 712 holds, in conjunction with contact spring 710, the moveable contact 706 in the closed position in contact with one or more terminals (not shown). The moveable contact 706 moves freely within a guide member 716 disposed on the body member 712. In the normal operation range or breaking range (e.g., less than 2500 amperes), a relatively large functional gap 718 is maintained. FIG. 7B illustrates the dynamic adjustable magnetic yoke assembly 700 of FIG. 7A during short-circuit. In FIG. 7B, the yoke springs 708 have collapsed allowing the upper yoke 702 to move downward toward the lower yoke 704, thus reducing the functional gap 718 and increasing the Lorentz forces 720 between the yokes 702, 704.

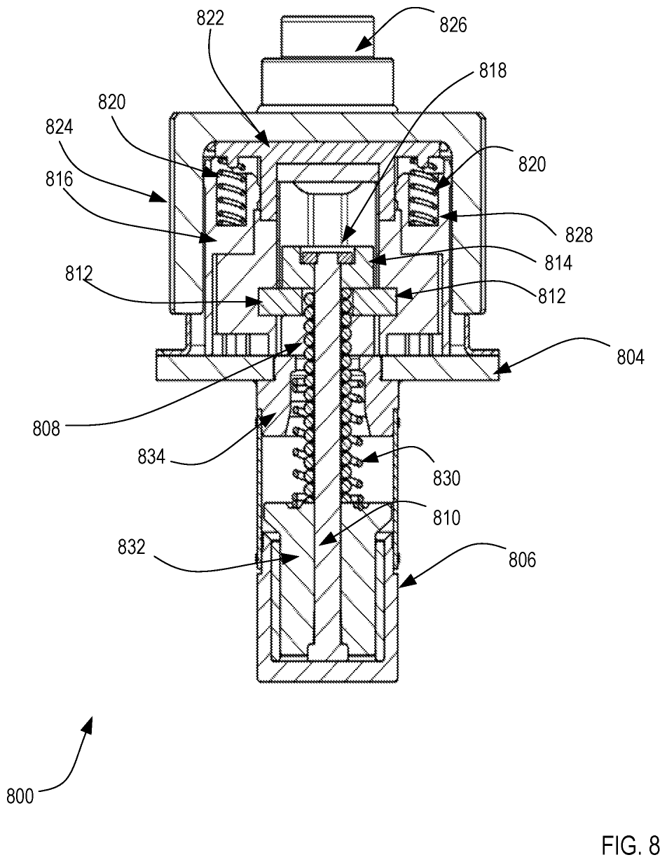

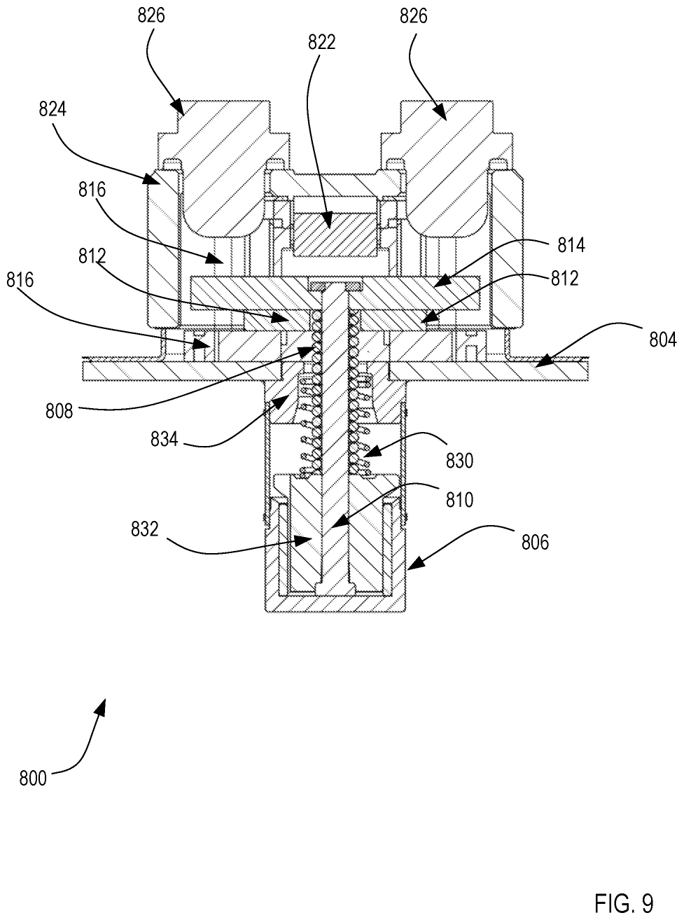

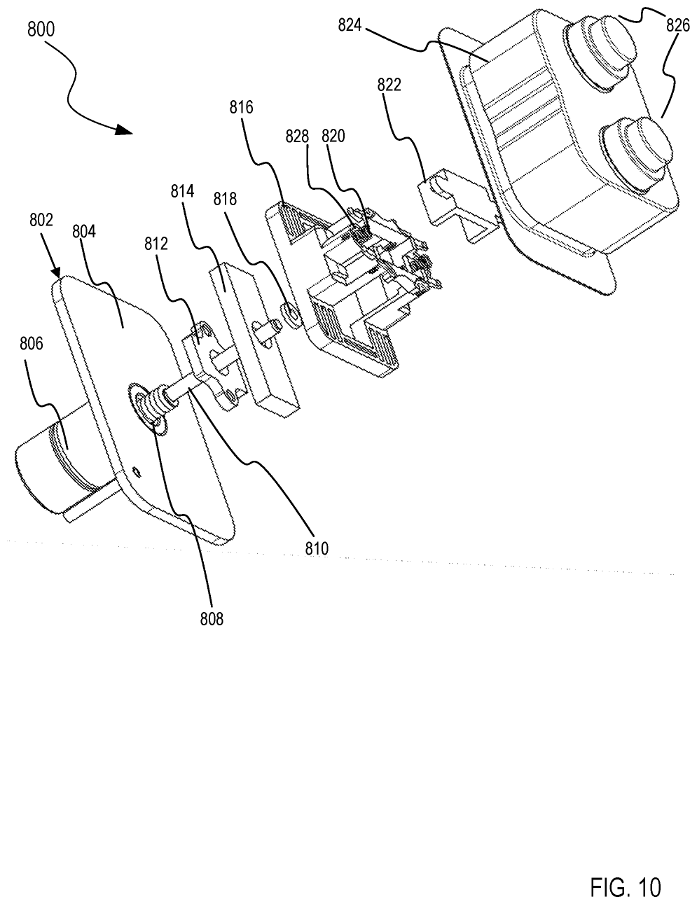

For further explanation, an example electromechanical switching device 800 utilizing a dynamic adjustable magnetic yoke assembly for electromechanical switching devices is described with reference to FIGS. 8-11. FIG. 8 sets forth a diagram illustrating a sectional view of the example electromechanical switching device 800 utilizing a dynamic adjustable magnetic yoke assembly in accordance with at least one embodiment of the present disclosure. The view of FIG. 8 shows the electromechanical switching device 800 when the switch is open, for example, in a non-actuated state when the switch is off or during circuit breaking conditions. FIG. 9 sets forth a diagram illustrating another sectional view of the example electromechanical switching device 800 utilizing a dynamic adjustable magnetic yoke assembly according to at least one embodiment of the present disclosure. The view of FIG. 9 is rotated 90 degrees relative to the view of FIG. 8. FIG. 10 sets forth a diagram illustrating an exploded view of the example electromechanical switching device 800 utilizing a dynamic adjustable magnetic yoke assembly according to at least one embodiment of the present disclosure.

The example electromechanical switching device 800 includes a body 802 having a mounting platform 804 and a cylindrical base 806. The base 806 at least partially houses a contact spring 808 and a plunger shaft 810 that hold a movable contact 814 in a closed position when the electromechanical switching device 800 is actuated and the switch is on. The electromechanical switching device 800 also includes a ferromagnetic lower yoke 812. In some examples, the lower yoke 812 is coupled to the moveable contact 814 (e.g., by rivets). In other examples, the lower yoke 812 is not coupled to the moveable contact 814 and moves independent of the moveable contact 814. In either case, the lower yoke 812 interfaces with the moveable contact 814 to provide additional force to hold the moveable contact 814 in the closed position when the electromechanical switching device 800 is actuated. The lower yoke 812 includes an aperture through which the plunger shaft 810 passes. The moveable contact 814 is composed of a conductive material (e.g., copper) and is configured to contact one or more terminals 826 of the electromechanical switching device 800. The moveable contact 814 includes an aperture that receives the plunger shaft 810. The electromechanical switching device 800 may include a contact ring 818 that secures the shaft 810 to the moveable contact 814.

The electromechanical switching device 800 also includes a support member 816 for positioning various components of the electromechanical switching device 800. For example, the lower yoke 812 and moveable contact 814 may move freely within the support member 816 through apertures in the sides of the support member 816. The support member 816 includes two receptacles 828 for stabilizing one or more collapsible bias member that are represented in FIG. 8 by yoke springs 820. A ferromagnetic upper yoke 822 is positioned and stabilized on the support member 816 by the springs 820. Although springs are depicted in FIG. 8 as the collapsible bias members, at least some embodiments are not so limited and may encompass other types of collapsible bias member as discussed above. In some examples, the yoke springs 820 are affixed to the upper yoke 822. The yoke springs 820 allow a degree of freedom up and down along the axis defined by the plunger shaft 810. Current in the moveable contact 814 induces anti-levitation Lorentz forces between the yokes 812, 822, causing the yokes 812, 822 to clamp the moveable contact 814 thereby providing additional force, along with the contact spring 808 and the plunger shaft 810, to hold the moveable contact 814 in the closed position when the electromechanical switching device 800 is actuated. During short-circuit conditions, when the current exceeds a selected trigger current, the Lorentz forces between the yokes 812, 822 overcome the spring force of the coil springs 820, thus causing the coil springs 820 collapse. That is, the spring force of the springs 820 may be selected in accordance with the desired trigger current, such that at and above the trigger current creates Lorentz forces between the yokes 812, 822 that will overcome the spring force and collapse the spring. The collapse of the yoke springs 820 allows the upper yoke 822 to approach the lower yoke 812 thus reducing the functional gap between the yokes 812, 822. The reduced functional gap allows for even stronger Lorentz forces, thus increasing the force applied by the yokes 812, 822 to retain the closed position of the movable contact 814 during short circuit.

The electromechanical switching device 800 also includes a housing 824 that is couplable to the body 802, thus creating a chamber for the yokes 812, 822, yoke springs 820, and support member 816, and movable contact 814. The housing 824 includes one or more terminal contacts 826 for coupling to an external current source. The example electromechanical switching device 800 also includes a return spring 830 that is disposed between a plunger base 832, which is coupled to the plunger shaft 810, and a return spring stop 834. The return spring 830 provides a bias force against the plunger base 832 to push the plunger base 832 and plunger shaft 810 in a direction away from the terminal contacts 826, which in turn drives the moveable contact 814 out of contact with the terminal contacts 826. In the position shown in FIG. 9, the moveable contact 814 is sufficiently removed from the terminal contacts 826 to prevent arcing.

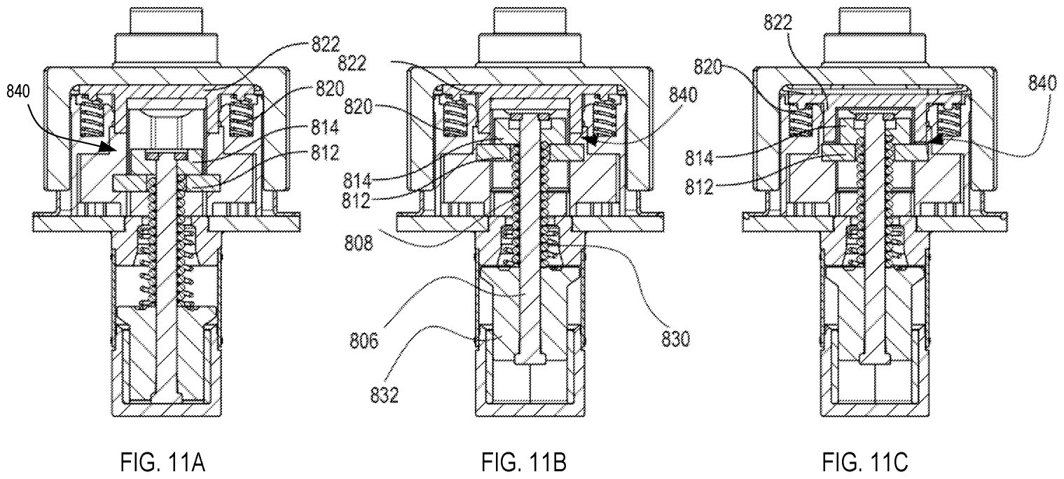

For further explanation, an example operation of the example electromechanical switching device 800 utilizing a dynamic adjustable magnetic yoke assembly according to at least one embodiment of the present disclosure is described with reference to FIGS. 11A-11C. Like FIG. 8, FIG. 11A sets forth a sectional view of the example electromechanical switching device 800 when the switch is open, for example, in a non-actuated state when the switch is off or during circuit breaking conditions. In this position, the functional gap 840 between the upper yoke 822 and the lower yoke 812 is at a mechanical maximum for switching device 800.

FIG. 11B sets forth a sectional view of the example electromechanical switching device 800 when the switch is closed and operating under normal (i.e., non-faulted) current conditions. In FIG. 11B, the electromechanical switching device 800 is in the actuated state, such that the plunger shaft 810 and contact spring 808 hold the moveable contact 814 in contact with the terminal contacts 826 to allow current to flow between the terminal contacts 826 through the moveable contact 814. In the actuated state, the lower yoke 812 is also moved, through actuation of the plunger shaft 810, toward the upper yoke 822 thus reducing the functional gap 840 to a predetermined distance for a normal mode of operation. The moveable contact 814, due to its abutment with the terminal contacts 826, prevents the lower yoke 812 from moving closer to the upper yoke 822 than this predetermined distance. Thus, the position of the lower yoke 812 is static when the switch is in the closed state. At this predetermined distance, the anti-levitation forces are sufficient for the lower yoke 812 to clamp the moveable contact 814 against the terminal contacts 826, while still allowing quick separation of the contacts 814, 826 during a break. The predetermined distance for the normal mode of operation may be characterized as the minimum distance between the upper yoke 822 and the lower yoke 812 without movement of the upper yoke 822.

The example of FIG. 11B illustrates the electromechanical switching device 800 in operation before a first trigger current is reached, where the trigger current is a current in the electromechanical switching device 800 at which the yoke springs 820 begin to collapse. Consider an example where the trigger current is selected to be 2500 amperes, and where the yoke springs 820 are selected to have a spring force that can withstand Lorentz forces between the upper yoke 822 and the lower yoke 812 while the current in the switching device 800 is below 2500 amperes. When the current in the switching device 800 reaches 2500 amperes, the Lorentz forces counteracting the spring force causes the yoke springs 820 to begin collapsing.

FIG. 11C sets forth a sectional view of the example electromechanical switching device 800 when the switch is closed and operating under short-circuit conditions. After a trigger current is reached, the collapse of the yoke springs 820 allows the upper yoke 822 to be pulled toward the lower yoke 812, thus reducing the distance of the functional gap 840. As current in the switch at above the trigger current increases, the Lorentz forces also increase and counteract the spring force of the yoke springs 820, thus causing the upper yoke 822 to be pulled away from the housing 824 and toward the lower yoke 812, further reducing the functional gap 840. Continuing the above example, consider that the electromechanical switching device 800 is configured to respond to a short-circuit condition where the current in the switching device 800 is 4000 amperes or greater. At and above 4000 amperes, the Lorentz forces between the upper yoke 822 and the lower yoke 812 overtake the opposing spring force of the yoke springs 820 and cause a full collapse (i.e., full compression) of the yoke springs 820, further reducing the functional gap to a minimum possible functional gap for the switching device 800. The further reduction of the functional gap further increases the Lorentz forces between the upper yoke 822 and the lower yoke 812, thereby increasing the force applied by the lower yoke 812 to the moveable contact 814 to hold the moveable contact 814 against the terminal contacts 826 during a short-circuit condition.

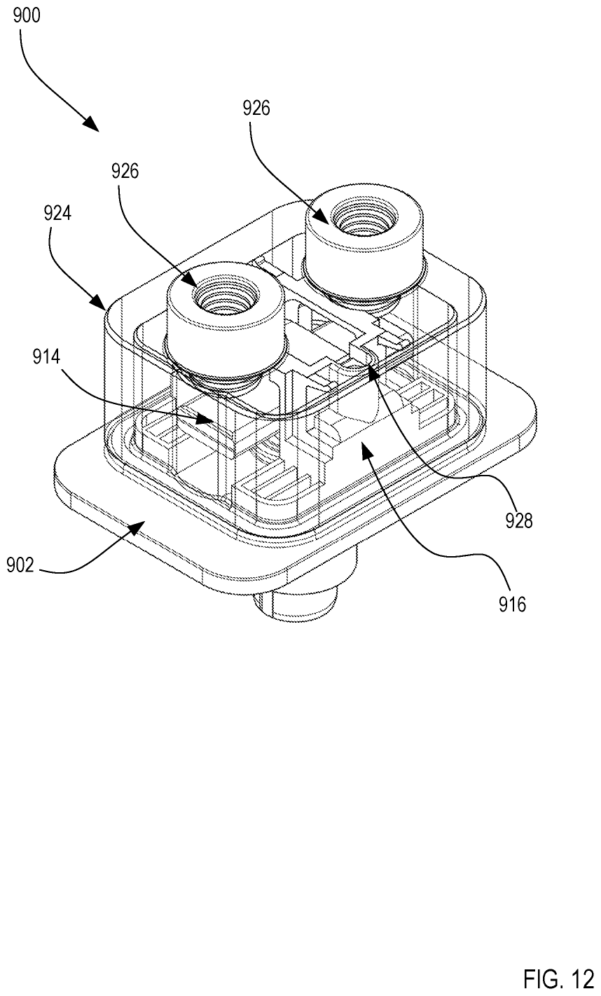

For further explanation, FIG. 12 illustrates a diagram of an upper isometric view of a switching device 900 that utilizes a dynamic adjustable magnetic yoke assembly according to at least one embodiment of the present disclosure. The switching device 900 includes a body 902 and a support member 916 disposed on the body 902 within a housing 924. A moveable contact 914 disposed within an interior cavity of the support member 916 moves within the support member 916 such that, when the switching device 900 is closed, the moveable contact 914 is placed in contact with one or more terminal contacts 926. The support member 916 includes one or more receptacles 928 to seat one or more collapsible bias members (not shown).

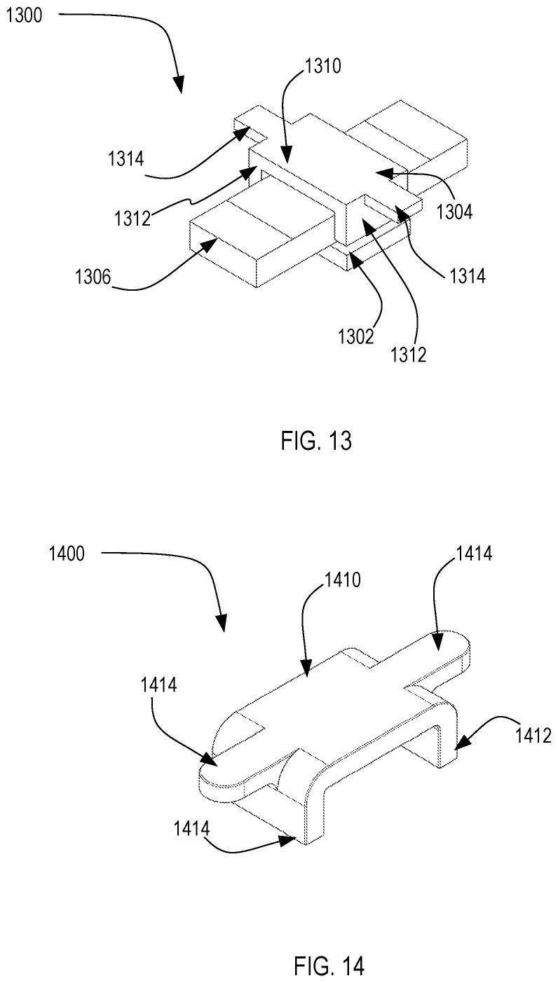

For further explanation, FIG. 13 illustrates a diagram of an upper isometric view of a dynamic adjustable magnetic yoke assembly 1300 according to at least one embodiment of the present disclosure. The yoke assembly 1300 includes a ferromagnetic upper yoke 1304 that is generally U-shaped, having a base portion 1310 and two arms 1312 extending perpendicular to the base portion 1310. The base portion 1310 includes two tab portions 1314 extending from either end past the arms 1312, where the tab portions 1314 are configured to engage a collapsible bias member (not shown). The yoke assembly 1300 also includes a ferromagnetic lower yoke 1302 that interfaces with a contact 1306. The contact 1306 fits between the arms 1312 of the upper yoke 1304.

For further explanation, FIG. 14 illustrates a diagram of an upper isometric view of a magnetic upper yoke 1400 of a dynamic adjustable magnetic yoke assembly according to at least one embodiment of the present disclosure. The ferromagnetic upper yoke 1400 is generally U-shaped, having a base portion 1410 and two arms 1412 extending perpendicular to the base portion 1410. The base portion 1410 includes two tab portions 1314 extending from both ends past the arms 1412, where the tab portions 1414 are configured to engage a collapsible bias member (not shown).

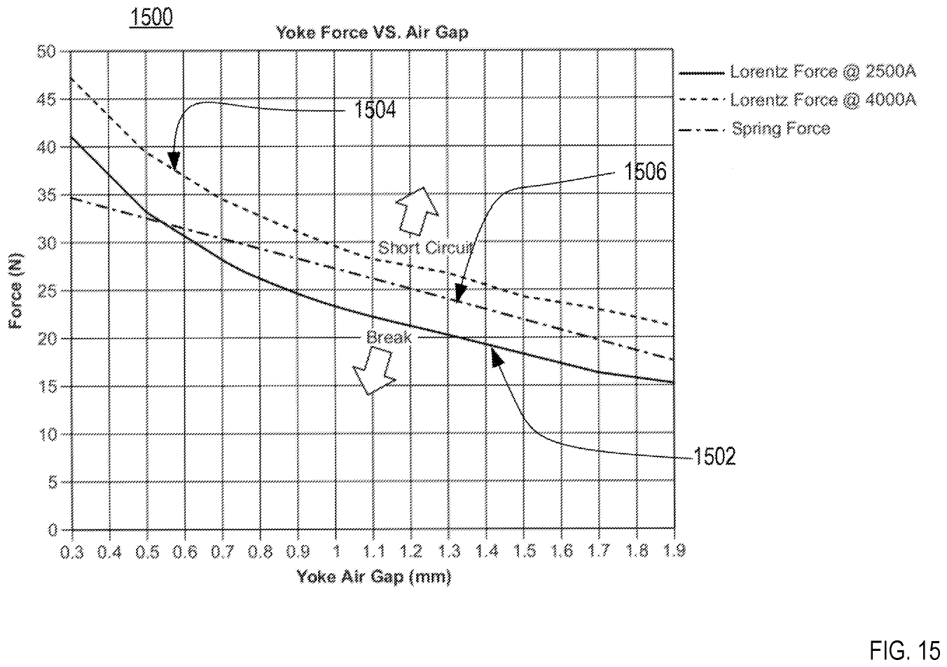

For further explanation, FIG. 15 illustrates an example graph 1500 plotting sample Lorentz forces and a sample spring force as a function of the distance of an functional gap between yokes of a dynamic adjustable magnetic yoke assembly according to at least one embodiment of the present disclosure. The y-axis represents Lorentz forces between an upper yoke and a lower yoke as measured in Newtons. The x-axis represents the distance of the functional gap between the upper yoke and the lower yoke. Curve 1502 illustrates Lorentz forces at 2500 amperes (e.g., a break condition) while curve 1504 illustrates Lorentz forces at 4000 amperes (e.g., a short-circuit condition). Curve 1506 illustrates the spring force of the yoke springs of the dynamic adjustable magnetic yoke assembly. As can be seen in the example, the spring force of the yoke springs should always exceed the Lorentz force when the current in the electromechanical switching device is less than 2500 A (during break) and the Lorentz force should always exceed the spring force when the current in the electromechanical switching device is greater than 4000 A (during short-circuit). Between 2500 amperes and 4000 amperes, the yoke springs should begin collapsing.

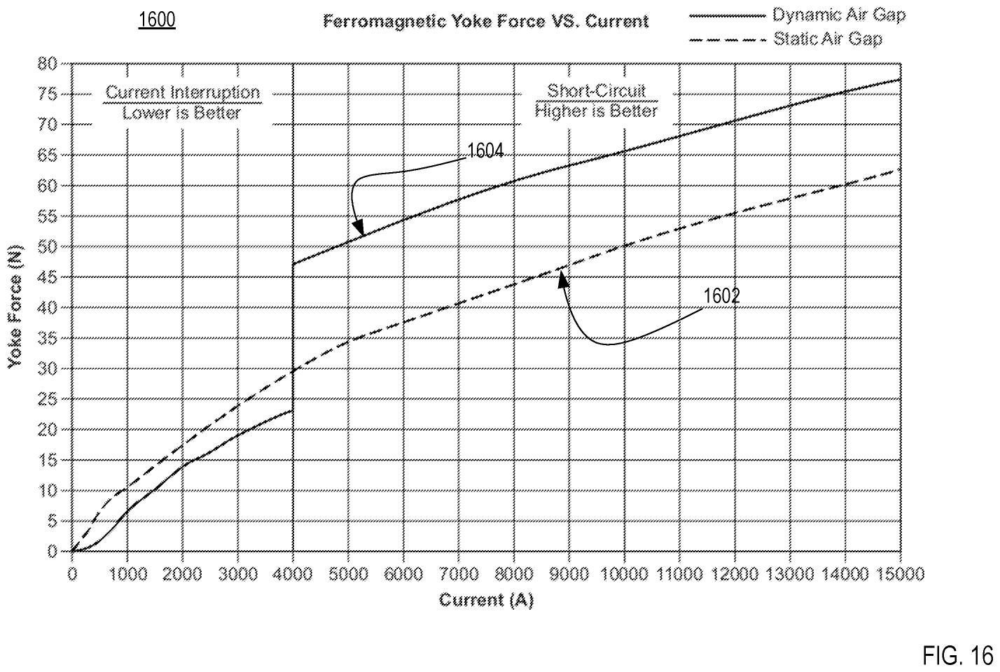

For further explanation, FIG. 16 illustrates an example graph 1600 plotting sample yoke forces as a function of current in an electromechanical switch utilizing a dynamic adjustable magnetic yoke assembly according to at least one embodiment of the present disclosure. A lower yoke force is desirable for current interruption (e.g., when less than a short-circuit current) and a higher yoke force is desirable for short-circuit protection (e.g., when at or above a short circuit current). In the example of FIG. 16, 4000 amperes is selected to be the short-circuit current. In a switching device that uses a static functional gap, as represented by curve 1602, it can be seen that the yoke force does not respond differently to current interruption conditions than it does to short-circuit conditions. In a switching device that utilizes a dynamic adjustable functional gap in accordance with the present disclosure, as represented by curve 1604, it can be seen that the yoke force increases drastically in response to a short circuit condition by reducing the functional gap between the yokes of the yoke assembly.

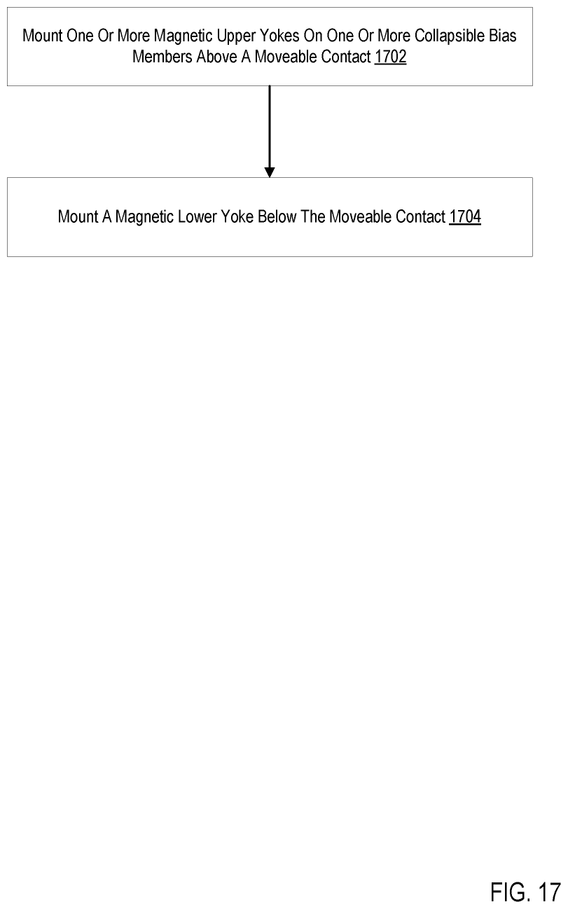

For further explanation, FIG. 17 illustrates a flowchart of an example method of manufacture for a dynamic adjustable magnetic yoke assembly for electromechanical switching devices according to some embodiments of the present disclosure. The method of FIG. 17 includes mounting 1702 a magnetic upper yoke on one or more collapsible bias members above a moveable contact 506, 814. In some examples, mounting 1702 the magnetic upper yoke is carried out by mounting the magnetic upper yoke 502, 822 on one or more yoke springs 508, 820. In other examples, mounting 1702 the magnetic upper yoke 502, 822 is carried out by mounting the magnetic upper yoke 602 on one or more break-away structures 608. In some examples, the collapsible bias members are seated on a support member 816. In some examples, the moveable contact 506, 814 moves within an interior cavity of the support member. The method of FIG. 17 also includes mounting 1704 a magnetic lower yoke 504, 604, 812 below the moveable contact 506, 814. In some examples, the moveable contact 506, 814 sits on or is coupled to the magnetic lower yoke 504, 604, 812. In some examples, the lower yoke moves with the moveable contact within the interior cavity of the support member 816.

Advantages and features of the present disclosure can be further described by the following statements:
1. An electromechanical switching device having a dynamic adjustable magnetic yoke assembly, the switching device comprising: a moveable contact; one or more magnetic upper yokes provided above the moveable contact; a magnetic lower yoke provided below the moveable contact; and one or more collapsible bias members supporting the upper yoke.
2. The switching device of statement 1, wherein the one or more collapsible bias members include one or more springs.
3. The switching device of statement 1 or 2, wherein the one or more collapsible bias members include one or more break-away structures.
4. The switching device of any of statements 1-3 further comprising: a support member having one or more cavities to seat the one or more collapsible bias members, wherein the one or more magnetic upper yokes are mounted on the one or more collapsible bias members.
5. The switching device of any of statements 1-4 further comprising: a dynamically adjustable functional gap between the one or more magnetic upper yokes and the magnetic lower yoke, wherein a distance of the functional gap varies in dependence upon a current in the switching device.
6. The switching device of any of statements 1-5, wherein the dynamically adjustable functional gap has a first distance when the switching device is in an actuated state and the current in the switching device is below a first level; wherein the dynamically adjustable functional gap has a second distance when the switching device is in an actuated state and the current in the switching device is at or above a second level; wherein the first distance is greater than the second distance; and wherein the second level is greater than the first level.
7. The switching device of any of statements 1-6, wherein the second level is indicative of a short circuit.
8. The switching device of any of statements 1-7, wherein the one or more collapsible bias members provide a bias force to the one or more magnetic upper yokes in a direction away from the magnetic lower yoke and in opposition to an attractive magnetic force generated between the one or more magnetic upper yokes and the magnetic lower yoke.
9. The switching device of any of statements 1-8, wherein the one or more collapsible bias members are selected to provide the bias force such that the attractive magnetic force generated between the one or more magnetic upper yokes and the magnetic lower yoke at a predetermined current level is greater than the bias force.
10. The switching device of any of statements 1-9, wherein, when the current in the switching device is at or above the predetermined current level, the one or more collapsible bias members collapse in response to the attractive magnetic force generated between the one or more magnetic upper yokes and the magnetic lower yoke.
11. The switching device of any of statements 1-10, wherein the one or more magnetic upper yokes comprises a u-shaped yoke and the magnetic lower yoke comprises a flat yoke.
12. The switching device of any of statements 1-11, wherein the one or more magnetic upper yokes includes one or more tabs that engage the one or more collapsible bias members.
13. The switching device of any of statements 1-12, further comprising a plurality of terminals.
14. The switching device of any of statements 1-13, wherein the movable contact contacts the plurality of terminals when the switching device is in an actuated state.
15. A method of manufacturing an electromechanical switching device having a dynamic adjustable magnetic yoke assembly, the method comprising: mounting one or more magnetic upper yokes on one or more collapsible bias members above a moveable contact; and mounting a magnetic lower yoke below the moveable contact.
16. The method of statement 15, wherein the one or more collapsible bias members include one or more springs.
17. The method of statement 15 or 16, wherein the one or more collapsible bias members include one or more break-away structures.
18. The method of any of statements 15-17, wherein the one or more collapsible bias members are seated in a support member; and wherein the moveable contact is configured to move within an interior cavity of the support member.
19. The method of any of statements 15-18, wherein the one or more collapsible bias members provide a bias force to the one or more magnetic upper yokes in a direction away from the magnetic lower yoke and in opposition to an attractive magnetic force generated between the one or more magnetic upper yokes and the magnetic lower yoke.
20. The method of any of statements 15-19, wherein the one or more collapsible bias members are selected to provide the bias force such that the attractive magnetic force generated between the one or more magnetic upper yokes and the magnetic lower yoke at a predetermined current level is greater than the bias force.

In view of the foregoing, readers will appreciate that, unlike convention electromechanical switching devices, embodiments in accordance with the present disclosure utilize a dynamic functional gap that changes in response to applied current. This allows the yokes to be optimized, resulting in a design that can exceed the short circuit performance of a traditional static design without making significant trade-offs with other performance characteristics. During current interruption the functional gap is large and the generated force low, limiting the impact of the ferromagnetic yokes on current interruption performance. During short circuit the functional gap collapses to be very small, greatly increasing the generated force and providing desirable short circuit withstand performance.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. An electromechanical switching device having a dynamic adjustable magnetic yoke assembly, the switching device comprising:
a moveable contact;
one or more magnetic upper yokes provided above the moveable contact;
a magnetic lower yoke provided below the moveable contact; and
one or more collapsible bias members supporting the one or more magnetic upper yokes.

2. The switching device of claim 1, wherein the one or more collapsible bias members include one or more springs.

3. The switching device of claim 1, wherein the one or more collapsible bias members include one or more break-away structures.

4. The switching device of claim 1 further comprising:
a support member having one or more cavities to seat the one or more collapsible bias members, wherein the one or more magnetic upper yokes are mounted on the one or more collapsible bias members.

5. The switching device of claim 1 further comprising:
a dynamically adjustable functional gap between the one or more magnetic upper yokes and the magnetic lower yoke, wherein a distance of the functional gap varies in dependence upon a current in the switching device.

6. The switching device of claim 5, wherein the dynamically adjustable functional gap has a first distance when the switching device is in an actuated state and the current in the switching device is below a first level; wherein the dynamically adjustable functional gap has a second distance when the switching device is in an actuated state and the current in the switching device is at or above a second level; wherein the first distance is greater than the second distance; and wherein the second level is greater than the first level.

7. The switching device of claim 6, wherein the second level is indicative of a short circuit.

8. The switching device of claim 1, wherein the one or more collapsible bias members provide a bias force to the one or more magnetic upper yokes in a direction away from the magnetic lower yoke and in opposition to an attractive magnetic force generated between the one or more magnetic upper yokes and the magnetic lower yoke.

9. The switching device of claim 8, wherein the one or more collapsible bias members are selected to provide the bias force such that the attractive magnetic force generated between the one or more magnetic upper yokes and the magnetic lower yoke at a predetermined current level is greater than the bias force.

10. The switching device of claim 9, wherein, when the current in the switching device is at or above the predetermined current level, the one or more collapsible bias members collapse in response to the attractive magnetic force generated between the one or more magnetic upper yokes and the magnetic lower yoke.

11. The switching device of claim 1, wherein the one or more magnetic upper yokes comprises a u-shaped yoke and the magnetic lower yoke comprises a flat yoke.

12. The switching device of claim 11, wherein the magnetic upper yoke includes one or more tabs that engage the one or more collapsible bias members.

13. The switching device of claim 1, further comprising a plurality of terminals.

14. The switching device of claim 13, wherein the movable contact contacts the plurality of terminals when the switching device is in an actuated state.

15. A method of manufacturing an electromechanical switching device having a dynamic adjustable magnetic yoke assembly, the method comprising:
mounting one or more magnetic upper yokes on one or more collapsible bias members above a moveable contact; and
mounting a magnetic lower yoke below the moveable contact.

16. The method of claim 15, wherein the one or more collapsible bias members include one or more springs.

17. The method of claim 15, wherein the one or more collapsible bias members include one or more break-away structures.

18. The method of claim 15, wherein the one or more collapsible bias members are seated in a support member; and wherein the moveable contact is configured to move within an interior cavity of the support member.

19. The method of claim 18, wherein the one or more collapsible bias members provide a bias force to the one or more magnetic upper yokes in a direction away from the magnetic lower yoke and in opposition to an attractive magnetic force generated between the one or more magnetic upper yokes and the magnetic lower yoke.

20. The method of claim 19, wherein the one or more collapsible bias members are selected to provide the bias force such that the attractive magnetic force generated between the one or more magnetic upper yokes and the magnetic lower yoke at a predetermined current level is greater than the bias force.
